(19) United States
(12) Patent Application Publication
(10) Pub. No.: US 2005/0174595 A1
(43) Pub. Date: Aug. 11, 2005

(54) Systems and methods for print waste management and performance measurement

(75) Inventors: Timothy J. Walpus, Omaha, NE (US); John E. Christensen, Omaha, NE (US); Jeffrey G. Nowlin, Counsel Bluffs, IA (US); Scott J. Smith, Omaha, NE (US); Mark T. Tonack, Omaha, NE (US); Jay E. Greene III, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/776,363

(22) Filed: Feb. 10, 2004

(51) Int. Cl. G06F 15/00

(52) U.S. Cl. 358/1.14

(57) ABSTRACT

Systems and methods for monitoring printer usage in new and existing printer systems. In some cases, the systems include retrofitting a an existing printer and printer controlled combination. Such a retrofit can include a monitor coupled to the printer that is operable to provide an indication of status associated with the printer, and a microprocessor based system controller that includes a computer readable medium comprising instructions executable by the microprocessor to: receive an operator command; format the operator command into a command compatible with the printer and printer controller combination; provide the command compatible with the printer and printer controller combination to the printer controller; and receive the indication of status associated with the printer from the monitor. other methods and systems are also disclosed.

### BACKGROUND OF THE INVENTION

The present invention is related to printing systems. More particularly, the present invention relates to systems and methods for controlling, monitoring, and/or providing status in relation to a printing system.

Large printing systems often include one or more printers operated under the control of a main frame computer. Typically, only rudimentary commands for controlling the printer exist, and monitoring operation of the printer is very difficult. In part because of this, significant waste of stock quantity occurs. In some cases, operators start the wrong job for the stock quantity, or install a new roll of stock quantity before beginning a print job when a new roll of stock quantity is not necessary.

Hence, there exists a need in the art for advanced systems and methods to address at least the aforementioned limitations.

### BRIEF SUMMARY OF THE INVENTION

The present invention is related to printing systems. More particularly, the present invention relates to systems and methods for controlling, monitoring, and/or providing status in relation to a printing system.

Systems and methods are disclosed for controlling, monitoring, and/or providing status in relation to a printing system. In some cases, such systems and methods predict an amount of stock quantity that is required for a particular print job, and monitor the actual amount used in relation to the particular print job. The difference between the two is stored as a wasted amount in relation to the operator overseeing the print job. Using this information, an operator can be instructed on how to avoid waste and/or provided with incentives for avoiding waste.

Particular embodiments of the present invention provide retrofitted printing systems that include an existing printer and printer controller combination. The systems further include a monitor coupled to the printer that is operable to provide an indication of status associated with the printer, and a microprocessor based system controller coupled to the monitor and the printer controller. The system controller includes a computer readable medium that includes instructions executable by the microprocessor to: receive an operator command; format the operator command into a command compatible with the printer and printer controller combination; provide the command compatible with the printer and printer controller combination to the printer controller; and receive the indication of status associated with the printer from the monitor. In various cases, an encoder is coupled to a stock advance mechanism of the printer, and a monitor controller is provided that accepts information from the encoder. In formation from the encoder is provided to the system controller in a format acceptable to the system controller.

In some cases, the systems further include instructions executable by the microprocessor to: determine an actual length of the stock quantity utilized during a printing job; access the particular print job and based at least in part on the accessed print job, determine an optimum length of the stock quantity to be used; determine an actual length remaining on the stock quantity; compare the actual length remaining on the stock quantity and the optimum length of the stock quantity to be used; display the actual length remaining on the stock quantity on the display; display the optimum length of the stock quantity to be used on the display; compare the actual length of the stock quantity utilized and the optimum length of the stock quantity to be used; determine a waste associated with the particular print job; and/or log a status of the particular print job in relation to an operator associated with the particular print job and based at least in part on the status of the particular print job, form a rating of the operator.

Other embodiments of the present invention provide methods for retrofitting an existing printer and printer controller combination. The methods include coupling a system controller that includes a display to the printer controller. Further, a monitor is coupled to the printer. Such a monitor includes a monitor controller, and an encoder coupled to the stock advance mechanism of the printer. The method further includes: providing a graphical user interface on the display; receiving an operator command that indicates a particular print job via the graphical user interface; formatting the operator command into a command compatible with the printer and printer controller combination; providing the command compatible with the printer and printer controller combination to the printer controller; receiving the indication of status associated with the printer; based at least in part on the indication of status associated with the printer from the monitor, determining an actual length of the stock quantity utilized in relation to the particular print job; determining an optimum length of the stock quantity to be used in relation to the particular print job; comparing the actual length of the stock quantity utilized and the optimum length of the stock quantity to be used; and determining a waste associated with the particular print job.

In some cases, the methods further include determining an actual length remaining on the stock quantity; comparing the actual length remaining on the stock quantity and the optimum length of the stock quantity to be used; displaying the actual length remaining on the stock quantity on the display; and/or displaying the optimum length of the stock quantity to be used on the display. Further, the methods can include installing a new stock quantity on the printer based at least in part on the comparison of the actual length remaining on the stock quantity and the optimum length of the stock quantity to be used; logging a status of the particular print job in relation to an operator associated with the particular print job; and/or based at least in part on the status of the particular print job, rating the operator.

Yet other embodiments of the present invention provide methods for monitoring usage of a printer and printer monitor combination. Such methods include receiving an operator command indicating a particular print job. This operator command is formatted into a command compatible with the printer and printer controller combination. A printer status indication is received, and based at least in part on the indication of status from the printer, determining an actual length of a stock quantity utilized in relation to the particular print job. Further, an optimum length of the stock quantity to be used in relation to the particular print job is determined and compared to the actual length of the stock quantity utilized. From this, a waste associated with the particular print job can be determined. In some cases, the methods further include authenticating an operator in association with the particular print job; logging a status of the particular print job in relation to the operator; and based at least in part on the status of the particular print job, rating the operator.

This summary provides only a general outline of the embodiments according to the present invention. Many other objects, features, and advantages of the present invention will become more fully apparent from the following detailed description, the appended claims, and the accompanying drawings.

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 illustrates a prior art printer and printer controller combination;

FIG. 2 illustrates a retrofitted printer and printer controller combination in accordance with some embodiments of the present invention;

FIG. 3 illustrates an exemplary printer monitor in accordance with various embodiments of the present invention; and

FIG. 4 is a flow diagram illustrating a method in accordance with some embodiments of the present invention.

### DETAILED DESCRIPTION OF THE INVENTION

Systems and methods are disclosed for controlling, monitoring, and/or providing status in relation to a printing system. In some cases, such systems and methods predict an amount of stock quantity that is required for a particular print job, and monitor the actual amount used in relation to the particular print job. The difference between the two is stored as a wasted amount in relation to the operator overseeing the print job. Using this information, an operator can be instructed on how to avoid waste and/or provided with incentives for avoiding waste. Based on the disclosure provided herein, one of ordinary skill in the art will appreciate a number of uses and/or advantages associated with the systems and methods of the present invention.

Particular embodiments of the present invention provide retrofitted printing systems that include an existing printer and printer controller combination. As one example, the system can be applied to an existing combination of IBM 3800 printer and IBM OS 390 main frame computer. Based on this disclosure, one of ordinary skill in the art will appreciate that the systems can also be applied to other printer/printer controller combinations. The retrofit includes coupling a monitor to the printer that is operable to provide an indication of status associated with the printer. Further, a microprocessor based system controller is coupled to the monitor and to the printer controller. Such monitors can be any computer, mechanism, tool, and/or combination thereof that is capable of receiving and/or accessing information about the printer. Further, as just some examples, the indication of status associated with the printer can include an indication of an amount of stock quantity used, a movement of stock quantity, a stock quantity empty indication, a printing ongoing indication, a printing stopped indication, and/or the like. The system controller can be any microprocessor based device capable of receiving, processing, and/or providing information. As just one example, the system controller can be a personal computer.

Further, the system controller is associated with a computer readable medium. This computer readable medium can be, but is not limited to, a hard disk drive, a floppy diskette, a CD ROM, an optical memory, a tape memory, a random access memory, read only memory, a database server, and/or a combination thereof. Thus, in particular instances, some of the computer readable medium can be integrated with the system controller, while other portions of the computer readable medium is merely communicably coupled to the system controller. The computer readable medium includes instructions executable by the microprocessor to receive an operator command. Such operator commands can include, but are not limited to, start print job, select print job, stop print job, login, and the like.

The instructions are further executable by the microprocessor to format the operator command into a command compatible with the printer and printer controller combination. In some cases, the system controller and the printer/printer controller combination share a compatible command format. In such cases the formatting is a simple pass through. As another example, the command can be modified from one format to another format compatible with a legacy command structure of the printer and printer controller combination. A number of examples of command formats exist. For example, an IBM OS 390 main frame includes a command format/set. Another example of a command format is the Interactive Output Facility. This format is more fully documented in “IOF (Interactive Output Facility) User's Guide, Release 7H”, September 2002 by Triangle Systems, Inc. of Research Triangle Park, N.C. The entirety of the aforementioned document is incorporated herein by reference for all purposes. The computer readable medium also includes additional instructions that are executable to provide the command compatible with the printer and printer controller combination to the printer controller; and receive the indication of status associated with the printer from the monitor.

In various cases, an encoder is coupled to a stock advance mechanism of the printer, and a monitor controller is provided that accepts information from the encoder and provides the information to the system controller in a format acceptable to the system controller. The format acceptable to the system controller can, for example, be any format defined and used in relation to the software operational on a system controller. Further, the encoder can be any apparatus capable of providing information about the amount of stock processed through the printer. Thus, as one example, the encoder can indicate the number of turns made by an element in the printer, where the number of turns is indicative of the amount of stock passed through the printer. Further, as used herein, the term “stock quantity” means any continuous feed of material to be printed (e.g., printer or printing stock). In some cases, the stock quantity is a roll of paper or card stock that is unrolled as it is printed. In other cases, the stock quantity is a stack of precut material supplied in a feeder mechanism such as a paper tray on a printer. In yet other cases the stock quantity is a stack of material sheets that are connected one to another such as a stack of perforated paper sheets. Thus, based on the definition of stock quantity, a “stock advance mechanism” can be any mechanism that moves printed material through the printer, whether the stock quantity is a roll of paper, a stack of paper, a perforated stack of paper, or the like.

In some cases, the systems further include instructions executable by the microprocessor to determine an actual length of the stock quantity utilized during a printing job. This can be represented in feet, meters, or some other measurement. Other instructions are executable to access the particular print job and based at least in part on the accessed print job, determine an optimum length of the stock quantity to be used. This can include calculating the amount of stock quantity that will be required to perform the print job. Further, in some cases, the instructions are executable to determine an actual length remaining on the stock quantity, and to compare the actual length remaining on the stock quantity and the optimum length of the stock quantity to be used. Using this information it can be determined whether sufficient stock quantity remains to complete the job. This information can be displayed as part of a graphical user interface. Further instructions can compare the actual length of the stock quantity utilized and the optimum length of the stock quantity to be used. Based on this, an amount of waste can be determined. This waste information can be logged and/or associated with an operator overseeing the print job.

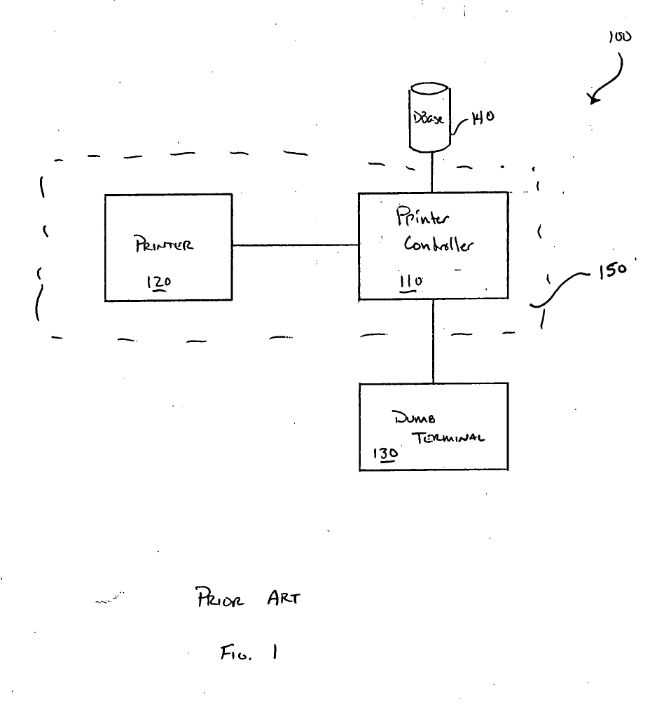

Turning to FIG. 1, an existing printer and printer controller combination 150 is illustrated. As suggested by the name, printer and printer controller combination 150 includes a printer 120, such as an IBM 3800 printer, and a printer controller 110 that in some cases is a main frame computer such as an IBM OS 390 computer. It should be recognized that other microprocessor based printer controllers can be used in relation to embodiments of the present invention. Printer controller 110 is communicably coupled to a database 140. Database 140 can include various information relevant to one or more print jobs to be run on printer 120. Further, a dumb terminal 130 can be communicably coupled to printer controller 110. Dumb terminal 130 can be an ASCII terminal capable of providing various commands to operate printer 120.

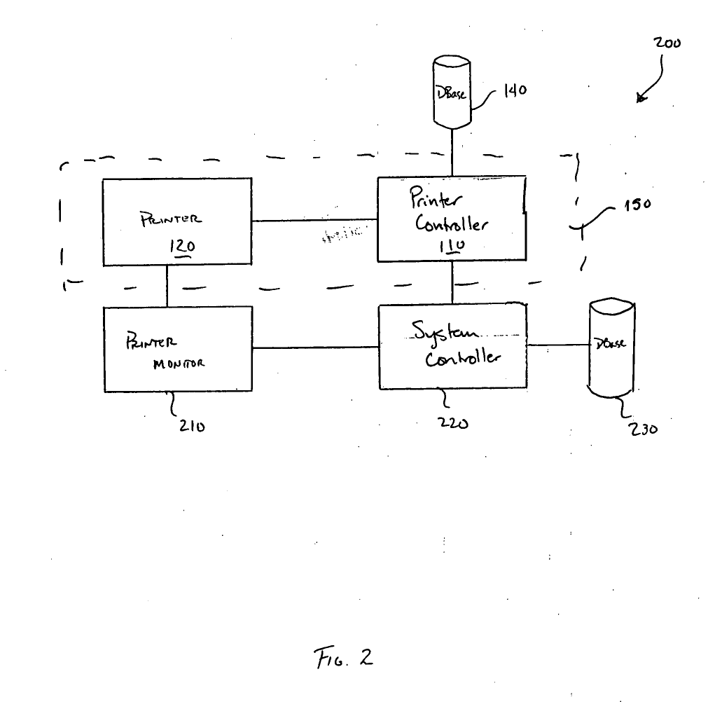

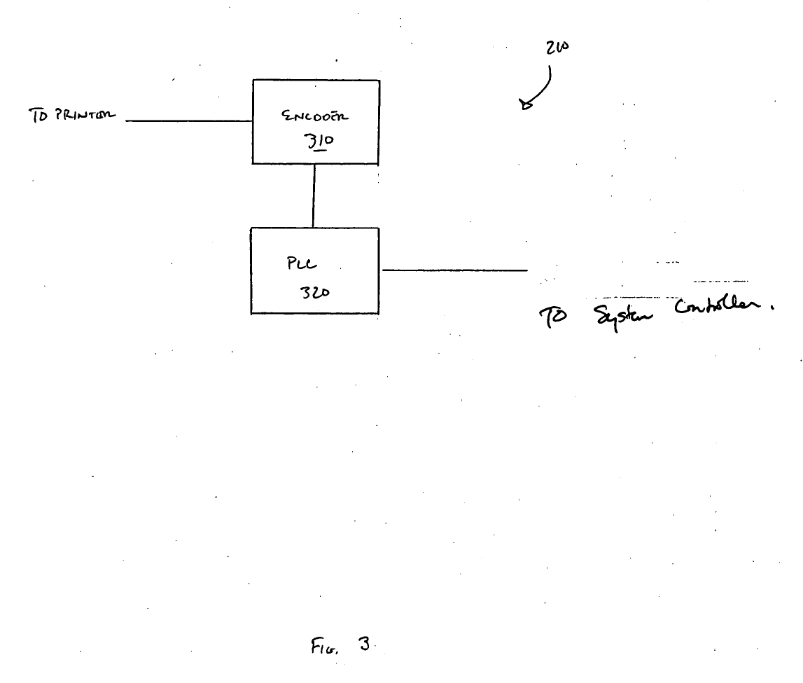

Turning to FIG. 2, a system 200 including a retrofit in accordance with some embodiments of the present invention is illustrated. System 200 includes printer and printer combination 150, as well as database 140. As illustrated, printer and printer combination 150 is retrofitted to include a printer monitor 210, a system controller 220, and a database 230. Printer monitor 210 can be a system retrofitted to printer 120 that is capable of identifying various operations and/or status of printer 120. Thus, for example, monitor 120 can determine if printer 120 is printing, stopped, how much stock quantity has been advanced through printer 120, and/or the like. The amount of stock quantity can include the amount over the lifetime of the printer, the amount since the stock quantity was most recently installed on the printer, and/or the amount for the particular print job. In some cases, some of the status and operational information is available directly from printer 120, while in other cases, the status and/or information is obtained by retrofitting additional hardware and control to printer 120. An example of such additional hardware is discussed below in relation to FIG. 3.

System controller 220 can be any microprocessor based device capable of receiving, processing, and/or providing information. As just one example, system controller 220 can be a personal computer. In particular cases, the personal computer can run an industry standard operating system, and provide a graphical user interface for entering commands for printer and printer controller combination 150. System controller 220 can be associated with a computer readable medium. Such a computer readable medium can be, but is not limited to, a hard disk drive, a floppy diskette, a CD ROM, an optical memory, a tape memory, a random access memory, read only memory, a database server, and/or a combination thereof. Thus, in particular instances, some of the computer readable medium can be integrated with system controller 220, while other portions of the computer readable medium is merely communicably coupled to system controller 220.

System controller 220 can also be communicably coupled to database 230. Database 230 can in some instances be considered part of the aforementioned computer readable medium. Database 230 can, among other things, store information about the operational efficiency of printer 120. For example, information about an optimum amount of stock quantity to be used in relation to a given print job, the actual amount of stock quantity used in relation to the print job, the calculated waste, and/or the operator overseeing the print job. This information can be aggregated across multiple print jobs, and based on this information, various operators using printer and printer controller combination 150 can be rated. In some cases, the operators can be provided with bonuses or other incentives based at least in part on the ratings.

Turning to FIG. 3, a block diagram of an exemplary printer monitor 210 is depicted. As illustrated, printer monitor 210 includes and encoder 310 and a Programmable Logic Controller (PLC) 320. Encoder 310 can be attached to the stock advance mechanism of printer 120. In one particular case, the stock advance mechanism is a rotating mechanism, and encoder 310 provides an output representative of the number of revolutions occurring during a print job. Such an encoder can include a disk that has slits that repeatedly break a light beam creating a pulsing light beam. A pulsing light beam indicates that the printer is active, and the number of pulses is indicative of the revolutions of the stock advance mechanism of printer 120. These revolutions equal a certain amount of stock quantity utilized. For example, one revolution of an encoder installed on an IBM 4000 printer can be equal to four inches of stock quantity. PLC 320 receives this revolution information from encoder 310 and calculates a length of stock quantity utilized. Based on this disclosure, one of ordinary skill in the art will appreciate a number of other encoders that can be selected depending upon the type of stock advance mechanism that is to be monitored. For example, where individual sheets are passed through printer 120, encoder 310 can be a sheet counter.

PLC 320 takes the information provided by encoder 310 and calculates the amount of stock quantity utilized. This information is then formatted and provided to system controller 220. In some cases, PLC 320 merely receives the raw information from encoder 310 and provides that information to system controller 220. In such cases, system controller 220 includes the capability of formatting the information, and calculating the amount of stock quantity utilized.

In some cases, where new stock quantity is installed in printer 120, the operator can enter an amount of stock quantity installed, and this amount can be decremented every time a print job is performed. Other times, a standard stock quantity amount is installed and the operator does not need to indicate the amount installed. The decrementing can be used to constantly update the amount of stock quantity available on printer 120. In some cases, where a new print job is being started, it can be determined if sufficient stock quantity is available in printer 120 to complete the selected print job. In various cases, print jobs can be selected based on the amount of stock quantity remaining. This can avoid the waste of relatively small amounts of stock quantity remaining at the end of a roll or other form of stock quantity. This information about the remaining stock quantity can be displayed to the operator via a graphical user interface running on system controller 220.

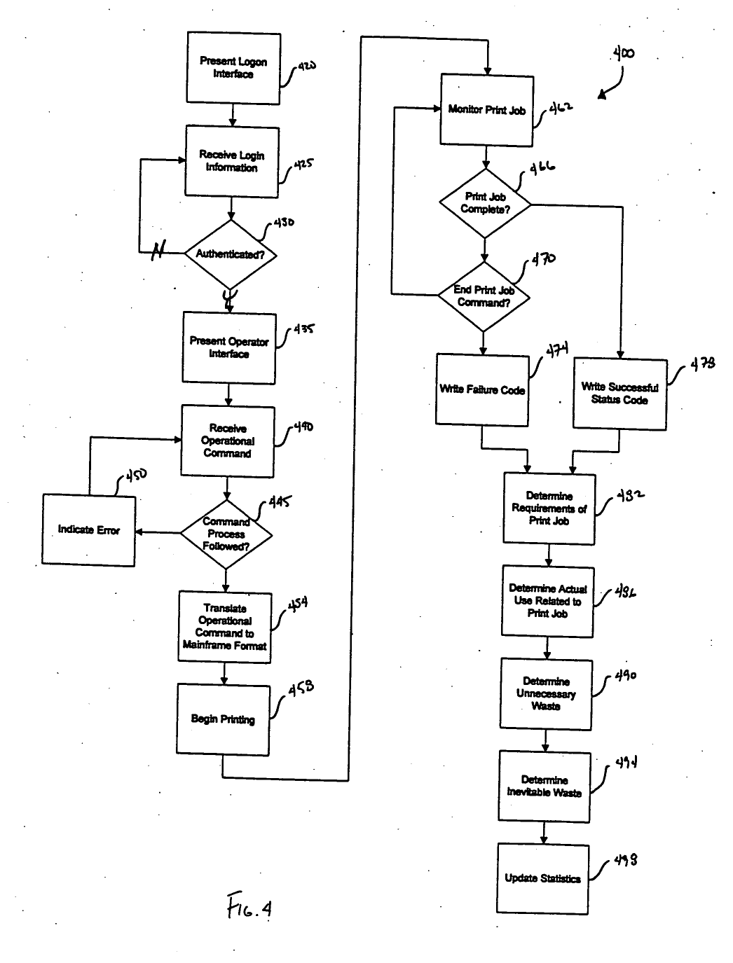

Various other uses of the stock quantity amount information are also possible in accordance with embodiments of the present invention. Some of these uses are disclosed more fully below in relation to FIG. 4. Turning to FIG. 4, a flow diagram 400 illustrates a method in accordance with some embodiments of the present invention. Following flow diagram 400, a login interface is provided by system controller 220 (block 420). Login information such as a username and password are received via the login interface (block 425). This information can then be authenticated, which in part can identify an operator utilizing the printer and printer controller combination 150 (block 430). Where the login information is insufficient for some reason (block 430), the information is again requested and the authentication process repeated. Alternatively, where the login information is sufficient (block 430), an operator interface is presented via system controller 220 (block 435).

One or more operational commands are received via the operator interface (block 440), and it is determined if the proper procedures have been implemented prior to performing the commands (block 445). Thus, for example, before a start print job command may be accepted, an operator may be required to turn power on to printer 120. Such checking can minimize waste by helping to assure that procedures are followed before a print job begins executing. Further, such checking can avoid the situation where duplicate statements are sent out resulting in a fine. Based on this disclosure, one of ordinary skill in the art will appreciate a number of procedural steps that may be assured before a given command is accepted. Where the procedures are not properly followed (block 445), an error is indicated identifying procedures that must first be completed (block 450). The operator can then complete those procedures, and re-enter the operational command (block 440). As one example of a procedure, it may be the case that where the print job terminates prematurely only the operator that started the job can restart the job and cause it to run to completion.

The received operational command can be formatted to be compatible with printer controller 110, and the command is passed to printer controller 110 (block 454). Where the command indicates the start of a printing job, the printing job is started (block 458). The status of the printing job is monitored (block 466). Once it is determined that the printing job is complete (block 466), a successful print complete status is written to database 230 (block 478). Otherwise, where the printing job is not yet complete, a print interrupt command or some error command may be received. Where such a command is not received (block 470), the print job continues (block 462). Alternatively, where such a command is received (block 470), the job is terminated and a failure code indicating the reason for terminating the print job is written to database 230 (block 474). These reasons can be reported in the form of event or error codes, such as for example, print job interrupted due to operator stoppage, due to fire drill at the plant, and/or other reasons.

In some cases, the requirements for a given print job are determined when an operational command identifying the print job is received (at about block 440). Alternatively, the print job requirements can be calculated later in the process (block 482). This calculation involves determining an amount of stock quantity required to complete the print job. Thus, for example, where one hundred statements are to be printed, and each statement requires twenty inches of stock quantity, a total of two thousand inches of stock quantity is required. Further, based on information gathered via printer monitor 210, an actual amount of stock quantity used can be determined (block 486). The difference between the actual amount used (block 486) and the amount required (block 482) is the calculated waste (block 490). In some cases an inevitable waste is allowed, and in one particular case, this is calculated as a percentage of the total requirement (block 494). This inevitable waste (block 494) is deducted from the actual waste (block 490), and all of this information is updated to database 230 (block 498). This information can then be used to determine efficiency characteristics of printing operations.

The invention has now been described in detail for purposes of clarity and understanding. However, it will be appreciated that certain changes and modifications may be practiced within the scope of the appended claims. Further, the functions of the systems and methods of using such are merely exemplary. Thus, although the invention is described with reference to specific embodiments and figures thereof, the embodiments and figures are merely illustrative, and not limiting of the invention. Rather, the scope of the invention is to be determined solely by the appended claims.

1. A retrofitted printing system including an existing printer and printer controller combination, the retrofitted printing system comprising:
a monitor coupled to the printer, wherein the monitor is operable to provide an indication of status associated with the printer; and
a microprocessor based system controller coupled to the monitor and the printer controller, wherein the system controller includes a computer readable medium, and
wherein the computer readable medium includes instructions executable by the microprocessor to:
receive an operator command;
format the operator command into a command compatible with the printer and printer controller combination;
provide the command compatible with the printer and printer controller combination to the printer controller; and
receive the indication of status associated with the printer from the monitor.

2. The retrofitted printing system including an existing printer and printer controller combination of claim 1, wherein the monitor comprises:
an encoder, wherein the encoder is coupled to a stock advance mechanism of the printer; and
a monitor controller, wherein the monitor controller is communicably coupled to the encoder and to the system controller, and wherein the monitor controller is operable to format information from the encoder to a format compatible with the system controller.

3. The retrofitted printing system including an existing printer and printer controller combination of claim 1, wherein a stock quantity is installed on the printer such that the printer is operable to print on the stock quantity, and wherein the computer readable medium further includes instructions executable by the microprocessor to:
determine an actual length of the stock quantity utilized.

4. The retrofitted printing system including an existing printer and printer controller combination of claim 3, wherein the operator command indicates a start of a particular print job, and wherein the computer readable medium further includes instructions executable by the microprocessor to:
access the particular print job; and
based at least in part on the accessed print job, determining an optimum length of the stock quantity to be used.

5. The retrofitted printing system including an existing printer and printer controller combination of claim 4, wherein the computer readable medium further includes instructions executable by the microprocessor to:
determine an actual length remaining on the stock quantity.

6. The retrofitted printing system including an existing printer and printer controller combination of claim 5, wherein the computer readable medium further includes instructions executable by the microprocessor to:
compare the actual length remaining on the stock quantity and the optimum length of the stock quantity to be used.

7. The retrofitted printing system including an existing printer and printer controller combination of claim 6, wherein the system controller includes a display, and wherein the computer readable medium further includes instructions executable by the microprocessor to:
display the actual length remaining on the stock quantity on the display; and
display the optimum length of the stock quantity to be used on the display.

8. The retrofitted printing system including an existing printer and printer controller combination of claim 4, wherein the computer readable medium further includes instructions executable by the microprocessor to:
compare the actual length of the stock quantity utilized and the optimum length of the stock quantity to be used.

9. The retrofitted printing system including an existing printer and printer controller combination of claim 8, wherein the computer readable medium further includes instructions executable by the microprocessor to:
determine a waste associated with the particular print job.

10. The retrofitted printing system including an existing printer and printer controller combination of claim 9, wherein the computer readable medium further includes instructions executable by the microprocessor to:
log a status of the particular print job in relation to an operator associated with the particular print job; and
based at least in part on the status of the particular print job, form a rating of the operator.

11. The retrofitted printing system including an existing printer and printer controller combination of claim 1, wherein the system controller includes a graphical user interface.

12. A method for retrofitting an existing printer and printer controller combination, the method comprising:
coupling a system controller to the printer controller, wherein the system controller includes a display;
coupling a monitor to the printer, wherein the monitor includes:
an encoder and a monitor controller, and wherein the encoder is coupled to a stock advance mechanism of the printer; and
a monitor controller, wherein the monitor controller is communicably coupled to the encoder and to the system controller;
providing a graphical user interface on the display;
receiving an operator command via the graphical user interface, wherein the operator command indicates a particular print job;
formatting the operator command into a command compatible with the printer and printer controller combination;
providing the command compatible with the printer and printer controller combination to the printer controller;
receiving the indication of status associated with the printer from the monitor;
based at least in part on the indication of status associated with the printer from the monitor, determining an actual length of the stock quantity utilized in relation to the particular print job;
determining an optimum length of the stock quantity to be used in relation to the particular print job;
comparing the actual length of the stock quantity utilized and the optimum length of the stock quantity to be used; and
determining a waste associated with the particular print job.

13. The method of claim 12, wherein the method further comprises:
determining an actual length remaining on the stock quantity.

14. The method of claim 13, wherein the method further comprises:
comparing the actual length remaining on the stock quantity and the optimum length of the stock quantity to be used.

15. The method of claim 14, wherein the method further comprises:
displaying the actual length remaining on the stock quantity on the display; and
displaying the optimum length of the stock quantity to be used on the display.

16. The method of claim 14, wherein the stock quantity is a first stock quantity, and wherein the method further comprises:
installing a second stock quantity on the printer based at least in part on the comparison of the actual length remaining on the stock quantity and the optimum length of the stock quantity to be used.

17. The method of claim 12, wherein the method further comprises:
logging a status of the particular print job in relation to an operator associated with the particular print job; and
based at least in part on the status of the particular print job, rating the operator.

18. A method for monitoring usage of a printer and printer monitor combination, the method comprising:
receiving an operator command indicating a particular print job;
formatting the operator command into a command compatible with the printer and printer controller combination;
providing the command compatible with the printer and printer controller combination to the printer controller;
receiving an indication of status from the printer;
based at least in part on the indication of status from the printer, determining an actual length of a stock quantity utilized in relation to the particular print job;
determining an optimum length of the stock quantity to be used in relation to the particular print job;
comparing the actual length of the stock quantity utilized and the optimum length of the stock quantity to be used; and
determining a waste associated with the particular print job.

19. The method of claim 18, wherein the method further comprises:
authenticating an operator in association with the particular print job.

20. The method of claim 19, wherein the method further comprises:
logging a status of the particular print job in relation to the operator; and
based at least in part on the status of the particular print job, rating the operator.
